(19) United States
(12) Patent Application Publication
(10) Pub. No.: US 2025/0224011 A1
(43) Pub. Date: Jul. 10, 2025

(54) DEVICE FOR SUPPRESSING LOW-FREQUENCY LINE SPECTRUM VIBRATION

(71) Applicant: Harbin Engineering University, Harbin (CN)

(72) Inventors: Tiangui YE, Harbin (CN); Yin HU, Harbin (CN); Yukun CHEN, Harbin (CN); Guoyong JIN, Harbin (CN); Xianglong MA, Shanghai (CN); Haoran LIU, Harbin (CN)

(21) Appl. No.: 19/027,766

(22) Filed: Jan. 17, 2025

Related U.S. Application Data
(63) Continuation of application No. PCT/CN2024/091154, filed on May 6, 2024.

(30) Foreign Application Priority Data
Jan. 8, 2024 (CN) 202410024771.8

(51) Int. Cl. F16F 7/01

(52) U.S. Cl. CPC F16F 7/015

(57) ABSTRACT

A device for suppressing low-frequency line spectrum vibration includes a main housing, a diaphragm assembly having an upper diaphragm and a lower diaphragm, and a particle damper arranged in the main housing. Two ends of the main housing are respectively provided with an upper end cover and a lower end cover. The upper diaphragm and the lower diaphragm are respectively installed at the two ends of the main housing through the upper end cover and the lower end cover; and a particle damper. Two ends of the particle damper are respectively connected to the upper diaphragm and the lower diaphragm, and the upper diaphragm and the lower diaphragm are used for transmitting external vibration energy into the particle damper, and the particle damper is used for dissipating vibration energy.

### CROSS-REFERENCE TO RELATED APPLICATIONS

This application is a continuation of PCT/CN2024/091154, filed May 6, 2024 and claims priority of Chinese Patent Application No. 202410024771.8, filed on Jan. 8, 2024, the entire contents of which are incorporated herein by reference.

### TECHNICAL FIELD

The present disclosure relates to the technical field of vibration reduction, and in particular relates to a device for suppressing low-frequency line spectrum vibration.

### BACKGROUND

With the continuous improvement of shipbuilding craftsmanship level and the wide application of vibration and noise reduction technology, the mechanical vibration caused by ship power and transmission devices is effectively suppressed. However, the excitation of ship power and transmission devices has broadband characteristics, and the actual system has rich vibration modes, leading to the increasingly prominent influence of low-frequency line spectrum vibration.

Traditional ship vibration and noise reduction technologies include vibration elimination, vibration isolation, vibration absorption, vibration suppression, structural optimization design, etc. These methods may only reduce the vibration magnitude in the whole frequency band, but it is difficult to eliminate the low-frequency vibration line spectrum caused by the low-speed operation of ship power and transmission devices. Active vibration control introduces a secondary vibration source into the controlled vibration system, and adjusts the active control force applied to the controlled system through a certain control strategy or algorithm, so that the vibration response generated by the active control force at the required position is offset with the vibration response of the original excitation. Therefore, active vibration control may adapt to the change of external disturbance frequency and has a good control effect on low-frequency line spectrum vibration. However, the active control system usually needs complex sensors, control algorithms and actuators, so the design and manufacturing cost of the system is relatively high. Because of the complex electronic and mechanical components involved, the active control system may need frequent maintenance, and the reliability of the system may be affected.

Therefore, there is an urgent need for a device for suppressing low-frequency line spectrum vibration to solve the above problems.

### SUMMARY

An objective of the present disclosure is to provide a device for suppressing low-frequency line spectrum vibration, so as to solve the problems existing in the prior art.

In order to achieve the above objective, the present disclosure provides the following solution: the present disclosure provides a device for suppressing low-frequency line spectrum vibration, including:
a main housing, where two ends of the main housing are respectively provided with an upper end cover and a lower end cover;
a diaphragm assembly including an upper diaphragm and a lower diaphragm, where the upper diaphragm and the lower diaphragm are respectively installed at the two ends of the main housing through the upper end cover and the lower end cover; and
a particle damper arranged in the main housing, where two ends of the particle damper are respectively connected to the upper diaphragm and the lower diaphragm, and the upper diaphragm and the lower diaphragm are used for transmitting external vibration energy into the particle damper, and the particle damper is used for dissipating vibration energy.

In some embodiments, the particle damper includes a damping box housing, a top end of the damping box housing is provided with a damping box cover, and the damping box cover and a bottom end of the damping box housing are respectively connected to the upper diaphragm and the lower diaphragm, and multiple damping particles are arranged in the damping box housing.

In some embodiments, the damping box cover is in threaded connection with the damping box housing, and multiple washers are arranged between the damping box cover and the damping box housing.

In some embodiments, a top end of the damping box cover and the bottom end of the damping box housing are both boss structures, and center positions of the boss structures, the upper diaphragm and the lower diaphragm are each provided with multiple first mounting holes, and a first bolt is arranged in each of the first mounting holes.

In some embodiments, the two ends of the main housing, the upper end cover, the lower end cover, the upper diaphragm and the lower diaphragm are each provided with multiple second mounting holes along a circumferential direction, and a second bolt is arranged in each of the second mounting holes.

In some embodiments, the upper diaphragm and the lower diaphragm are circular metal sheets, and hollow patterns are arranged on each of the circular metal sheets.

In some embodiments, a thickness of each of the upper diaphragm and the lower diaphragm is 0.1 millimeter (mm) to 1 mm.

In some embodiments, a material of the upper diaphragm and the lower diaphragm is one of beryllium copper, titanium alloy, nickel-based alloy or high-strength steel.

In some embodiments, a material of the damping particles is one of iron-based particles, tungsten-based particles, copper particles, lead particles or ceramic particles.

In some embodiments, the damping particles have a particle size of 0.1 mm to 5 mm, and a filling ratio of 10% to 90%.

Compared with the prior art, the present disclosure has the following advantages and technical effects.

According to the device for suppressing the low-frequency line spectrum vibration provided by the present disclosure, the diaphragm assembly broadens the frequency range of vibration absorption, and transfers the external vibration energy to the particle damper through targeted energy transfer, providing a high amplitude condition for the particle damper to improve the damping performance of the particle damper, and ultimately effectively dissipating vibration energy through the particle damper. The present disclosure has the characteristics of simple structure, high stability, broadband vibration absorption and high damping, and may be used for suppressing low-frequency line spectrum vibration.

### BRIEF DESCRIPTION OF THE DRAWINGS

In order to explain the embodiments of the present disclosure or the technical solution in the prior art more clearly, the drawings needed in the embodiments will be briefly introduced below. Apparently, the drawings in the following description are only some embodiments of the present disclosure. For one of ordinary skill in the art, other drawings may be obtained according to these drawings without creative effort.

FIG. 1 is a schematic diagram of an internal structure of a device of an embodiment according to the present disclosure.

FIG. 2A is a schematic structural diagram of an upper diaphragm with circular hollow patterns according to the present disclosure.

FIG. 2B is a schematic structural diagram of an upper diaphragm structure with a spiral hollow pattern according to the present disclosure.

FIG. 3 shows force-displacement curves of diaphragm assemblies with different thicknesses according to the present disclosure.

FIG. 4 is a schematic structural diagram of another embodiment of the present disclosure.

FIG. 5 is a schematic structural diagram of the yet another embodiment of the present disclosure.

### DETAILED DESCRIPTION OF THE EMBODIMENTS

In the following, the technical solutions in the embodiments of the present disclosure will be clearly and completely described with reference to the attached drawings. Apparently, the described embodiments are only a part of the embodiments of the present disclosure, but not all the embodiments. Based on the embodiments in the present disclosure, all other embodiments obtained by one of ordinary skill in the art without creative effort belong to the protection scope of the present disclosure.

In order to make the above objects, features and advantages of the present disclosure more obvious and easier to understand, the present disclosure will be further described in detail with the attached drawings and specific embodiments.

### Embodiment 1

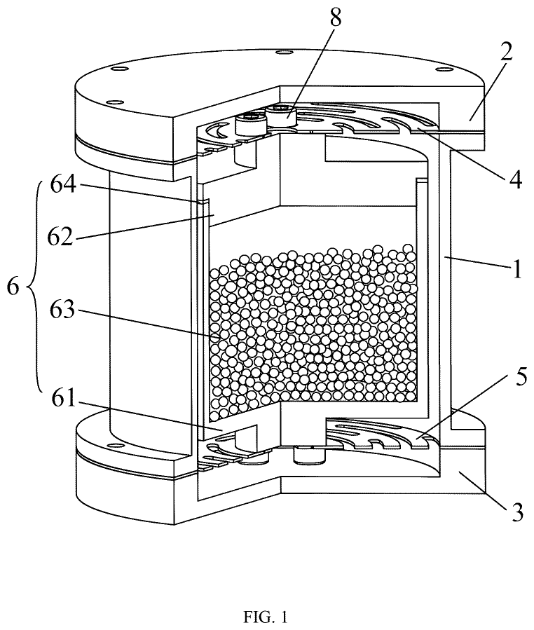

With reference to FIG. 1 to FIG. 3, the present disclosure provides a device for suppressing low-frequency line spectrum vibration, including a main housing 1, a diaphragm assembly and a particle damper 6.

Two ends of the main housing 1 are respectively provided with an upper end cover 2 and a lower end cover 3.

The diaphragm assembly includes an upper diaphragm 4 and a lower diaphragm 5, and the upper diaphragm 4 and the lower diaphragm 5 are respectively installed at two ends of the main housing 1 through the upper end cover 2 and the lower end cover 3; and

The particle damper 6 is arranged in the main housing 1, two ends of the particle damper 6 are respectively connected to the upper diaphragm 4 and the lower diaphragm 5, and the upper diaphragm 4 and the lower diaphragm 5 are used for transmitting external vibration energy into the particle damper 6, and the particle damper 6 is used for dissipating vibration energy.

Further, the particle damper 6 includes a damping box housing 61, the top end of the damping box housing 61 is provided with a damping box cover 62, and the damping box cover 62 and the bottom end of the damping box housing 61 are respectively connected to the upper diaphragm 4 and the lower diaphragm 5, and multiple damping particles 63 are arranged in the damping box housing 61.

The damping box housing 61 is located in the main housing 1, and the external vibration energy is transferred to the particle damper 6, and the vibration energy is effectively dissipated through the collision and friction of the damping particles 63 in the particle damper 6.

Further, the damping box cover 62 is in threaded connection with the damping box housing 61, and multiple washers 64 are arranged between the damping box cover 62 and the damping box housing 61.

With reference to FIG. 1, the device has several washers 64 arranged in contact with each other along the axial direction. The damping box cover 62 is in threaded connection with the damping box housing 61 and arranged in contact with the washers 64. The height of the damping box cover 62 is adjusted by increasing or decreasing the number of washers 64, thereby adjusting the overall height of the particle damper 6 and causing initial deformation of the upper diaphragm 4 and the lower diaphragm 5 at both ends, forming geometric nonlinearity for designing and adjusting nonlinear stiffness.

Further, the top end of the damping box cover 62 and the bottom end of the damping box housing 61 are both boss structures, and the center positions of the boss structures, the upper diaphragm 4 and the lower diaphragm 5 are each provided with first mounting holes 7, and a first bolt 8 is arranged in each of the first mounting holes 7.

With reference to FIG. 1, the boss structures on the top end of the damping box cover 62 and the bottom end of the damping box housing 61 are symmetrically arranged, and are respectively connected to the upper diaphragm 4 and the lower diaphragm 5 through the first bolts 8 and the first mounting holes 7, forming additional masses at the centers of the upper diaphragm 4 and the lower diaphragm 5 with fixed peripheries, and the forced motion displacement is greater than the thickness of each of the upper diaphragm 4 and the lower diaphragm 5, resulting in nonlinear stiffness.

Further, the two ends of the main housing 1, the upper end cover 2, the lower end cover 3, the upper diaphragm 4 and the lower diaphragm 5 are each provided with second mounting holes 9 along the circumferential direction, and a second bolt 10 is arranged in each of the second mounting holes 9.

The installation between the two ends of the main housing 1, the upper end cover 2, the lower end cover 3, the upper diaphragm 4 and the lower diaphragm 5 is realized by arranging the second bolts 10 and the second mounting holes 9. The upper diaphragm 4 and the lower diaphragm 5 are tightly attached to the two ends of the main housing 1, and the upper end cover 2 and the lower end cover 3 are tightly attached to the upper diaphragm 4 and the lower diaphragm 5, achieving internal sealing of the device and protecting internal components.

Further, the upper diaphragm 4 and the lower diaphragm 5 are circular metal sheets, and hollow patterns are arranged on each of the circular metal sheets.

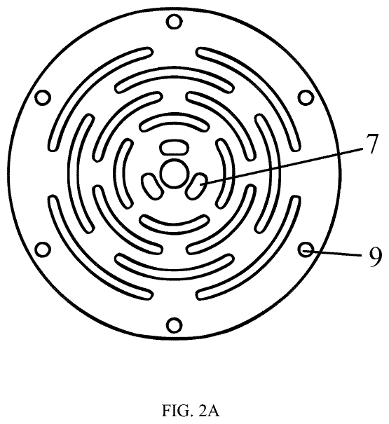

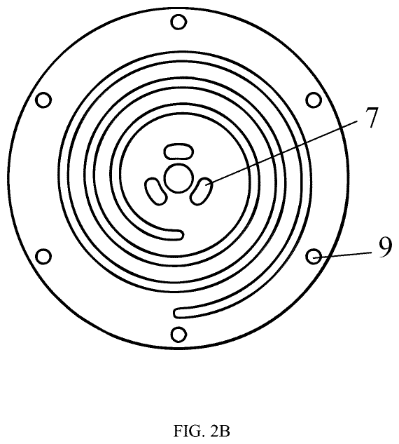

With reference to FIG. 2A and FIG. 2B, FIG. 2A shows circular hollow patterns, and FIG. 2B shows a spiral hollow pattern. By setting and selecting the upper diaphragm 4 and the lower diaphragm 5 with hollow patterns, the stiffness ranges of the upper diaphragm 4 and the lower diaphragm 5 are adjusted.

Further, the thickness of each of the upper diaphragm 4 and the lower diaphragm 5 is 0.1 mm to 1 mm.

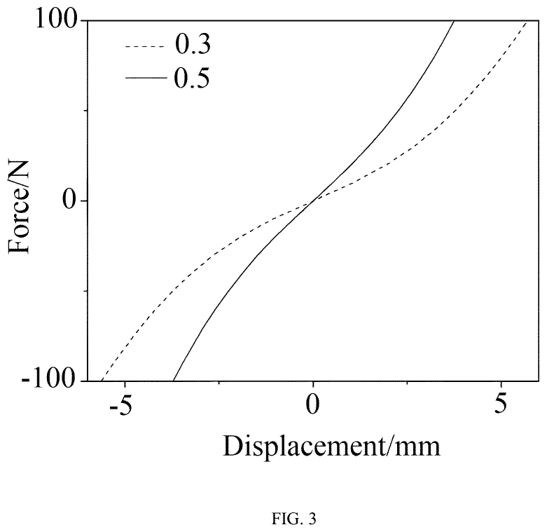

With reference to FIG. 3, according to the vibration absorption frequency band required by the actual working conditions, the appropriate thicknesses of the upper diaphragm 4 and the lower diaphragm 5 are selected.

Further, the material of the upper diaphragm 4 and the lower diaphragm 5 is one of beryllium copper, titanium alloy, nickel-based alloy or high-strength steel.

The upper diaphragm 4 and the lower diaphragm 5 are made of one of beryllium copper, titanium alloy, nickel-based alloy or high-strength steel, all of which are high-strength and fatigue-resistant materials.

Further, the material of the damping particles 63 is one of iron-based particles, tungsten-based particles, copper particles, lead particles or ceramic particles.

By selecting the material of the damping particles 63, the vibration energy may be effectively dissipated through the collisions and frictions among the damping particles 63.

Further, the particle size of damping particles 63 is 0.1 mm to 5 mm, and the filling ratio is 10% to 90%.

The nonlinear damping may be adjusted by selecting the damping particles 63 with different particle sizes and adjusting different filling ratios.

The diaphragm assembly has nonlinear stiffness, and the nonlinear stiffness comes from the upper diaphragm 4 and the lower diaphragm 5. The upper diaphragm 4 and the lower diaphragm 5 are thin, and the amplitude is greater than the thickness of each of the upper diaphragm 4 and the lower diaphragm 5 during vibration, resulting in nonlinear stiffness as shown in FIG. 3.

The nonlinear damping comes from the collision and friction energy consumption of damping particles 63 in particle damper 6, belonging to a highly nonlinear damping.

The diaphragm assembly broadens the frequency range of vibration absorption, and transfers the external vibration energy to the particle damper 6 through targeted energy transfer, providing a high amplitude condition for the particle damper 6 to improve the damping performance of the particle damper 6, and ultimately effectively dissipating vibration energy through the particle damper 6.

The device is connected to the structure to be damped by bolts. When the device is subjected to vibration in the vibration absorption frequency domain, the system including the diaphragm assembly and the particle damper 6 generates strong resonance, and the external vibration energy is transmitted to the device, and finally the vibration energy is dissipated through the collisions and frictions of damping particles 63 in particle damper 6.

### Embodiment 2

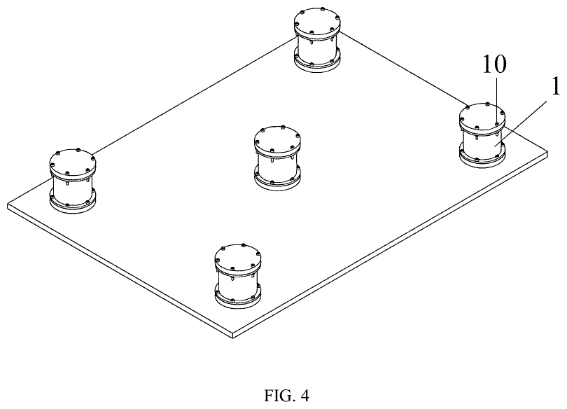

With reference to FIG. 4, the device in this embodiment is connected to the object to be damped by bolts, nuts and the mounting holes of the upper end cover 2 or the lower end cover 3, and multiple devices may be distributed and arranged in parallel according to actual needs.

According to the vibration reduction frequency, the upper diaphragms 4 and the lower diaphragms 5 with different thicknesses and hollow structures are selected, and damping particles 63 with different masses are filled to adjust different vibration absorption frequency bands, and multiple vibration absorption frequency bands are used together.

The devices are mainly arranged at positions such as the parts with intense vibration, the vibration transmission paths, and antinodes of modal shapes of elastomers, achieving good vibration reduction effects. As shown in FIG. 4, the devices are arranged according to the modal shape of the flat plate.

### Embodiment 3

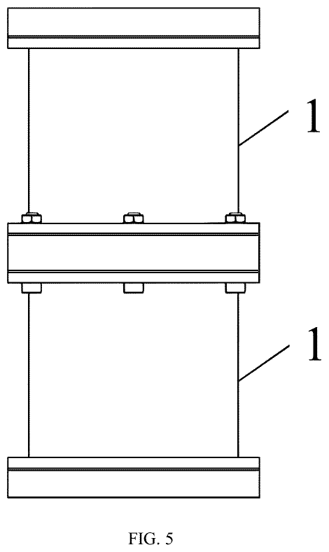

With reference to FIG. 5, in the scene with limited horizontal space, in this embodiment, two devices may be vertically connected in parallel through bolts and nuts. Similarly, devices with different vibration absorption frequency bands may be combined to broaden the vibration absorption frequency range.

When dealing with wide low-frequency line spectrum vibration, the vibration reduction frequency range is broadened by adjusting the vibration reduction frequency bands of the devices and using devices with two kinds of vibration reduction frequency bands vertically in parallel.

In the description of the present disclosure, it should be understood that the terms “longitudinal”, “transverse”, “up”, “down”, “front”, “back”, “left”, “right”, “vertical”, “horizontal”, “top”, “bottom”, “inside”, “outside”, etc. indicate orientation or positional relationships based on the orientation or positional relationships shown in the accompanying drawings, only for the convenience of describing the present disclosure, and do not indicate or imply that the device or element referred to must have a specific orientation, be constructed and operated in a specific orientation, and therefore cannot be understood as a limitation of the present disclosure.

The above-mentioned embodiments only describe the preferred mode of the present disclosure, and do not limit the scope of the present disclosure. Under the premise of not departing from the design spirit of the present disclosure, various modifications and improvements made by one of ordinary skill in the art to the technical solution of the present disclosure should fall within the protection scope of the present disclosure.

What is claimed is:

1. A device for suppressing low-frequency line spectrum vibration, comprising:
a main housing, wherein two ends of the main housing are respectively provided with an upper end cover and a lower end cover;
a diaphragm assembly comprising an upper diaphragm and a lower diaphragm, wherein the upper diaphragm and the lower diaphragm are respectively installed at the two ends of the main housing through the upper end cover and the lower end cover; and
a particle damper arranged in the main housing, wherein two ends of the particle damper are respectively connected to the upper diaphragm and the lower diaphragm, and the upper diaphragm and the lower diaphragm are used for transmitting external vibration energy into the particle damper, and the particle damper is used for dissipating vibration energy.

2. The device for suppressing low-frequency line spectrum vibration according to claim 1, wherein the particle damper comprises a damping box housing, a top end of the damping box housing is provided with a damping box cover, and the damping box cover and a bottom end of the damping box housing are respectively connected to the upper diaphragm and the lower diaphragm, and a plurality of damping particles are arranged in the damping box housing.

3. The device for suppressing low-frequency line spectrum vibration according to claim 2, wherein the damping box cover is in threaded connection with the damping box housing, and a plurality of washers are arranged between the damping box cover and the damping box housing.

4. The device for suppressing low-frequency line spectrum vibration according to claim 3, wherein a top end of the damping box cover and the bottom end of the damping box housing are both boss structures, and center positions of the boss structures, the upper diaphragm and the lower diaphragm are each provided with a plurality of first mounting holes, and a first bolt is arranged in each of the first mounting holes.

5. The device for suppressing low-frequency line spectrum vibration according to claim 1, wherein the two ends of the main housing, the upper end cover, the lower end cover, the upper diaphragm and the lower diaphragm are each provided with a plurality of second mounting holes along a circumferential direction, and a second bolt is arranged in each of the second mounting holes.

6. The device for suppressing low-frequency line spectrum vibration according to claim 1, wherein the upper diaphragm and the lower diaphragm are circular metal sheets, and hollow patterns are arranged on each of the circular metal sheets.

7. The device for suppressing low-frequency line spectrum vibration according to claim 1, wherein a thickness of each of the upper diaphragm and the lower diaphragm is 0.1 mm to 1 mm.

8. The device for suppressing low-frequency line spectrum vibration according to claim 1, wherein a material of the upper diaphragm and the lower diaphragm is one of beryllium copper, titanium alloy, nickel-based alloy or high-strength steel.

9. The device for suppressing low-frequency line spectrum vibration according to claim 2, wherein a material of the damping particles is one of iron-based particles, tungsten-based particles, copper particles, lead particles or ceramic particles.

10. The device for suppressing low-frequency line spectrum vibration according to claim 2, wherein the damping particles have a particle size of 0.1 mm to 5 mm and a filling ratio of 10% to 90%.
